(19) United States
(12) Patent Application Publication
(10) Pub. No.: US 2019/0129211 A1
(43) Pub. Date: May 2, 2019

(54) DISPLAY DEVICE AND METHOD OF MANUFACTURING THE SAME

(71) Applicant: Samsung Display Co. Ltd., Yongin-si (KR)

(72) Inventors: Jin Lak Kim, Suwon-si (KR); Su Min An, Cheonan-si (KR); Young Jun Kim, Seoul (KR)

(21) Appl. No.: 16/059,110

(22) Filed: Aug. 9, 2018

(30) Foreign Application Priority Data
Oct. 26, 2017 (KR) 10-2017-0140234

(51) Int. Cl. G02F 1/1339; G02F 1/1343; G02F 1/1335; G02F 1/1333; G02F 1/1368

(52) U.S. Cl. CPC G02F 1/1339; G02F 1/134309; G02F 1/133514; G02F 1/133512; G02F 2201/123; G02F 1/1368; G02F 2001/133519; G02F 2001/133357; G02F 2201/121; G02F 1/133345

(57) ABSTRACT

A display device and a method of manufacturing a display device. The display device includes a first insulation substrate and a second insulation substrate facing each other and each including a pixel region and a pixel boundary, a column spacer disposed on the second insulation substrate, and a common electrode disposed on the second insulation substrate, covering at least a part of the column spacer and including a conductive polymer.

### CROSS REFERENCE TO RELATED APPLICATION

This application claims priority from and the benefit of Korean Patent Application No. 10-2017-0140234, filed on Oct. 26, 2017, which is hereby incorporated by reference for all purposes as if fully set forth herein.

### BACKGROUND

### Field

Exemplary embodiments of the invention relate to a display device and a method of manufacturing the same.

### Discussion of the Background

A liquid crystal display device is utilized in various electronic appliances, such as TVs, monitors, notebooks, mobile phones, PDAs, and smart phones. In the liquid crystal display device, a liquid crystal layer is disposed between a lower panel and an upper panel, and an alignment angle of liquid crystal molecules is controlled to adjust transmittance, thereby displaying an image. A column spacer is disposed on the upper panel to maintain a cell gap.

The alignment angle of liquid crystal molecules is controlled by an electric field. The liquid crystal display device includes a pixel electrode and a common electrode as electric field generation electrodes. Generally, the pixel electrode is provided on the lower panel, and the common electrode is provided on the upper panel.

Since the common electrode is made of a transparent material, it basically transmits light, whereas it can reflect a part of the transmitted light at an optical interface. Since the common electrode is located at the side of a display surface, it may cause the reflection of external light when exposed to external light, thereby deteriorating display quality. Since the refractive index of Indium Tin Oxide (“ITO”), generally used in manufacturing the common electrode, is about 1.8 to 1.9, there is a limitation in reducing reflectance.

The above information disclosed in this Background section is only for understanding of the background of the inventive concepts, and, therefore, it may contain information that does not constitute prior art.

### SUMMARY

Exemplary embodiments of the invention provide a display device with improved external light reflection.

Exemplary embodiments of the invention also provide a method of manufacturing a display device with improved external light reflection.

Additional features of the inventive concepts will be set forth in the description which follows, and in part will be apparent from the description, or may be learned by practice of the inventive concepts.

An exemplary embodiment of the inventive concepts provides a display device including a first insulation substrate and a second insulation substrate facing each other, each including a pixel region and a pixel boundary, a column spacer disposed on the second insulation substrate, and a common electrode disposed on the second insulation substrate, the common electrode covering at least a part of the column spacer and including a conductive polymer.

Another exemplary embodiment of the inventive concepts provides a method of manufacturing a display device including forming a column spacer on an insulation substrate, forming a composition layer including a conductive polymer and a solvent on the insulation substrate on which the column spacer is formed, and forming a common electrode including a conductive polymer by removing the solvent.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a plan layout view of a display device according to an exemplary embodiment of the inventive concepts.

FIG. 2 is a sectional view of a display device according to an exemplary embodiment of the inventive concepts.

FIG. 3 is a sectional view illustrating a thin film transistor substrate according to an embodiment;

FIG. 4 is a schematic sectional view illustrating a pixel electrode and a common electrode of a display device according to an exemplary embodiment of the inventive concepts.

FIG. 5 is a sectional view of an upper panel of a display device according to an exemplary embodiment of the inventive concepts.

FIG. 6, FIG. 7, and FIG. 8 are sectional views illustrating a method of manufacturing the upper panel of FIG. 5 according to process step.

FIG. 9 is a sectional view of an upper panel of a display device according to another exemplary embodiment of the inventive concepts.

FIG. 10 is a layout view of the common electrode of FIG. 9.

FIG. 11 is a sectional view of an upper panel of a display device according to still another exemplary embodiment of the inventive concepts.

FIG. 12 is a layout view of the common electrode of FIG. 11.

FIG. 13 is a sectional view of an upper panel of a display device according to still another exemplary embodiment of the inventive concepts.

FIG. 14 is a sectional view of an upper panel of a display device according to still another exemplary embodiment of the inventive concepts.

### DETAILED DESCRIPTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be implemented in another exemplary embodiment without departing from the spirit and the scope of the disclosure.

Unless otherwise specified, the illustrated exemplary embodiments are to be understood as providing exemplary features of varying detail of some exemplary embodiments. Therefore, unless otherwise specified, the features, components, modules, layers, films, panels, regions, aspects, etc. (hereinafter individually or collectively referred to as “elements”), of the various illustrations may be otherwise combined, separated, interchanged, and/or rearranged without departing from the spirit and the scope of the disclosure.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. To this end, the term “connected” may refer to physical, electrical, and/or fluid connection. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, exemplary embodiments of the present invention will be described with reference to the attached drawings.

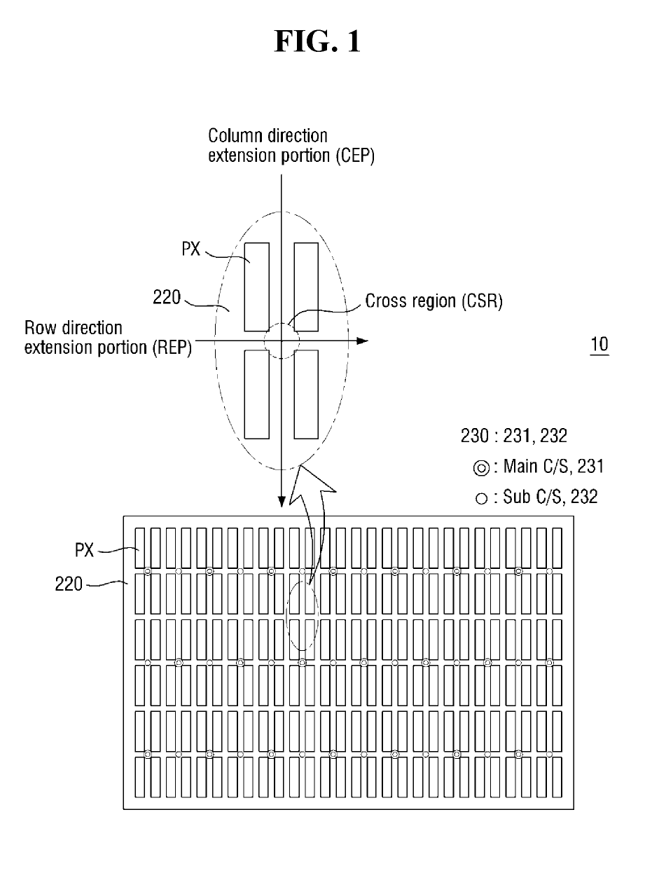

FIG. 1 is a plan layout view of a display device according to an exemplary embodiment of the inventive concepts.

Referring to FIG. 1, a display device 10 includes a plurality of pixels PX. The plurality of pixels PX may be arranged in a matrix shape. The plurality of pixels PX may be divided into a plurality of color pixels representing a specific color. For example, the plurality of pixels PX may include a plurality of red pixels, a plurality of green pixels, and a plurality of blue pixels. The red, green, and blue pixels may be alternately arranged.

A black matrix 220 is disposed at the boundary of each pixel PX to prevent the transmission of light. The black matrix 220 may have a lattice shape.

The display device 10 may include a lower panel 100 and an upper panel 200 facing each other, and may include a column spacer 230 functioning to maintain an interval therebetween. The column spacer 230 may be formed on the upper panel 200 or the lower panel 100.

The column spacer 230 may be located at the boundary of the pixels. The column spacer 230 may overlap the black matrix 220. In an exemplary embodiment, the column spacer 230 may be disposed on a cross region CSR where the row direction extension portion REP and column direction extension portion CEP of the black matrix 220 cross each other. However, the inventive concepts not limited thereto, and the column spacer 230 may be disposed on the row direction extension portion REP or column direction extension portion CEP of the black matrix 220.

The column spacer 230 may include a main column spacer 231 and a sub-column spacer 232. The main column spacer 231 may serve to maintain an interval between the upper panel 200 and the lower panel 100 under a general non-pressurized condition, and the sub-column spacer 232 may serve to maintain an interval between the upper panel 200 and the lower panel 100 under a pressurized condition. The height of the end of the sub-column spacer 232 may be smaller than the height of the end of the main column spacer 231. When the column spacer 230 is formed on the upper panel, the end of the main column spacer 231 may be in direct contact with the lower panel 100 under a non-pressurized condition, whereas the end of the sub-column spacer 232 may be spaced apart from the lower panel 100 without being in contact with the lower panel 100 under a non-pressurized condition.

The column spacer 230 need not be disposed for every cross region CSR. For example, one column spacer 230 may be disposed for each of three cross regions CSR, and the column spacers 230 can be arranged in various forms. The arrangement density of the main column spacers 231 is the same as the arrangement density of the sub-column spacers 232, but is the inventive concepts are not limited thereto.

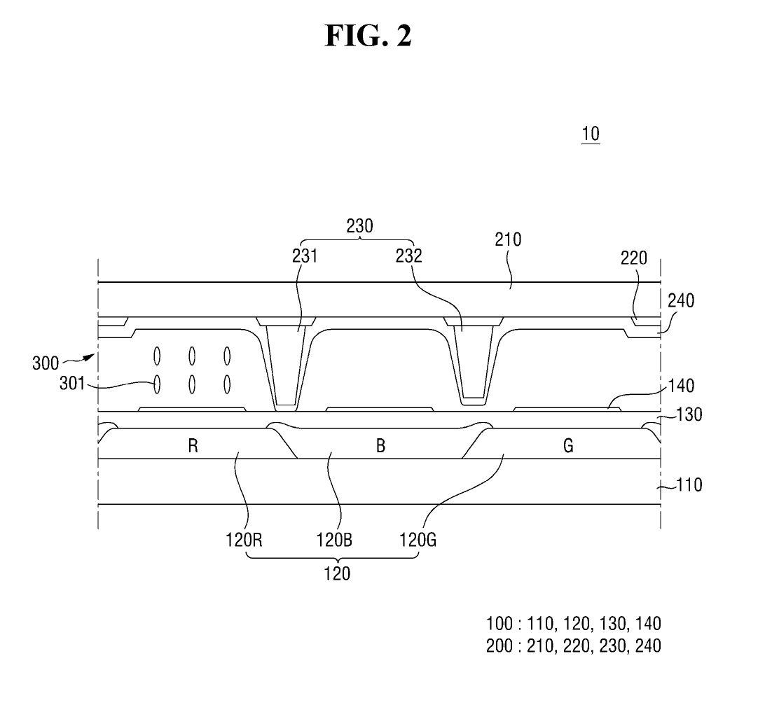

FIG. 2 is a sectional view of a display device according to an exemplary embodiment. For convenience of explanation, FIG. 2 shows a case where the main column spacer 231 and the sub-column spacer 232 are disposed at both sides of one pixel, respectively.

Referring to FIG. 2, the display device 10 includes the lower panel 100 and the upper panel 200, which face each other. A liquid crystal layer 300 is disposed between the lower panel 100 and the upper panel 200. Although not shown in the drawings, each of the lower panel 100 and the upper panel 200, which contact the liquid crystal layer 300, may be provided with an alignment film.

The lower panel 100 may include a first insulation substrate 110, a color filter 120, and a pixel electrode 140. The first insulation substrate 110 may be made of a transparent material, such as glass or quartz.

The color filter 120 and the pixel electrode 140 may be disposed on the first insulation substrate 110. The color filter 120 may be disposed between the first insulation substrate 110 and the pixel electrode 140. The color filter 120 and the pixel electrode 140 may be disposed for each pixel. The color filter 120 may include a red color filter 120R, a blue color filter 120B, and a green color filter 120G.

The color filters 120 of adjacent pixels may partially overlap each other. The color filter 120 may produce a step on the upper boundary surfaces of the color filters 120. In this case, the problem of the step can be solved by disposing a planarization film 130 on the color filter 120. The pixel electrode 140 may be disposed on the planarization film 130.

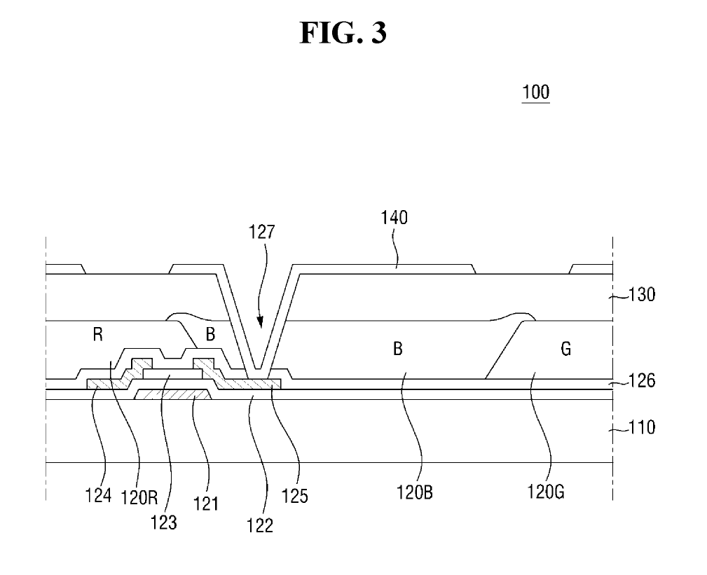

The pixel electrode 140 may be provided for each pixel, and a pixel voltage may be applied to the pixel electrode 140 by a separate switching element. The switching element may include a thin film transistor. The structure of an exemplary lower panel 100, including a thin film transistor, is shown in FIG. 3. Hereinafter, the term “thin film transistor substrate” refers to a substrate including a thin film transistor.

FIG. 3 is a sectional view illustrating a thin film transistor substrate according to an exemplary embodiment. Referring to FIGS. 1 to 3, a gate electrode 121 is disposed on the first insulation substrate 110. The gate electrode 121 is connected to a gate line extending in the row direction along the boundary of the pixels PX. The gate line may overlap the row direction extension portion REP of the black matrix 220. A gate insulation film 122 is disposed on the gate electrode 121, and a semiconductor layer 123 is disposed on the gate insulation film 122. The semiconductor layer 123 may contain a silicon semiconductor such as amorphous silicon or polycrystalline silicon or an oxide semiconductor such as indium gallium zinc oxide (IGZO). A source electrode 124 and a drain electrode 125 spaced apart from the source electrode 124 are disposed on the semiconductor layer 125. The source electrode 124 is connected to a data line extending in the row direction along the boundary of the pixels. The data line may overlap the column direction extension portion CEP of the black matrix 220.

The gate electrode 121, the source electrode 124, and the drain electrode 125 constitute three terminals of the thin film transistor. The semiconductor layer becomes a channel of the thin film transistor. The thin film transistor may overlap the cross region CSR of the black matrix 220.

A passivation film 126 is disposed on the source electrode 124 and the drain electrode 125, and a color filter 120 is disposed on the passivation film 126. A planarization film 130 is disposed on the color filter 120, and a pixel electrode 140 is disposed on the planarization film 130. The pixel electrode 140 is electrically connected with the drain electrode 125 through a contact hole 127 penetrating the planarization film 130, the color filter 120 and the passivation film 126 to expose the drain electrode 125. The pixel electrode 140 may be made of a transparent conductive oxide material such as Indium Tin Oxide (“ITO”) or Indium Zinc Oxide (“IZO”).

Although FIG. 3 illustrates a thin film transistor substrate including a bottom gate type thin film transistor, a top gate type thin film transistor may also be applied.

Referring to FIG. 2 again, the upper panel 200 includes a second insulation substrate 210, a black matrix 220, a column spacer 230, and a common electrode 240.

The second insulation substrate 210 may be made of a transparent material, such as glass or quartz. The black matrix 220 is disposed on the second insulation substrate 210. The black matrix 220 may be disposed along the boundary of pixels, as described above. The black matrix 220 may be made of an organic or inorganic material including a photosensitive material, or may be made of an opaque inorganic material, such as a metal.

The column spacer 230 may be disposed on the black matrix 220. The column spacers 230 may be located on the boundary of pixels. The column spacer 230 may be made of an organic material including a photosensitive material. The column spacer 230 may be made of a transparent material, but the inventive concepts are not limited thereto. The main column spacer 231 and the sub-column spacer 232 may be simultaneously formed through a single mask process using the same material.

The common electrode 240 is disposed on the column spacer 230. The common electrode 240 faces the pixel electrode 140. The common electrode 240 is disposed over the plurality of pixels. A common voltage may be applied to the common electrode 240. The pixel voltage of the pixel electrode 140 and the common voltage of the common electrode 240 form an electric field in the liquid crystal layer 300 located therebetween. The pixel electrode 140 and the common electrode 240 may form a liquid crystal capacitor having the liquid crystal layer 300 as a dielectric.

The common electrode 240 may be an entirely connected integrated electrode. The common electrode 240 may serve as a passage for discharging static electricity when static electricity is generated in the display device 10.

The common electrode 240 may be disposed not only on the pixel region of the second insulation substrate 210 but also on the boundary of pixels, and may also be disposed on the column spacer 230, so as to cover the side wall and end portion of the column spacer 230. Since the common electrode 240 covers the column spacer 230, an electric field may be formed between the common electrode 240 and the pixel electrode 140 on the column spacer 230. Since the direction of the common electrode 240 on the sidewall of the column spacer 230 is different from that of the common electrode 240 on the pixel region, the direction of the electric field on the sidewall of the column spacer 230 is also different from that of the electric field on the pixel region. Thus, the alignment of liquid crystal molecules around the side wall of the column spacer 230 is changed, and thus, the transmittance thereof may also be changed. However, since the black matrix 220 covers the corresponding location on the common electrode 240, the leakage of light at the corresponding location can be minimized.

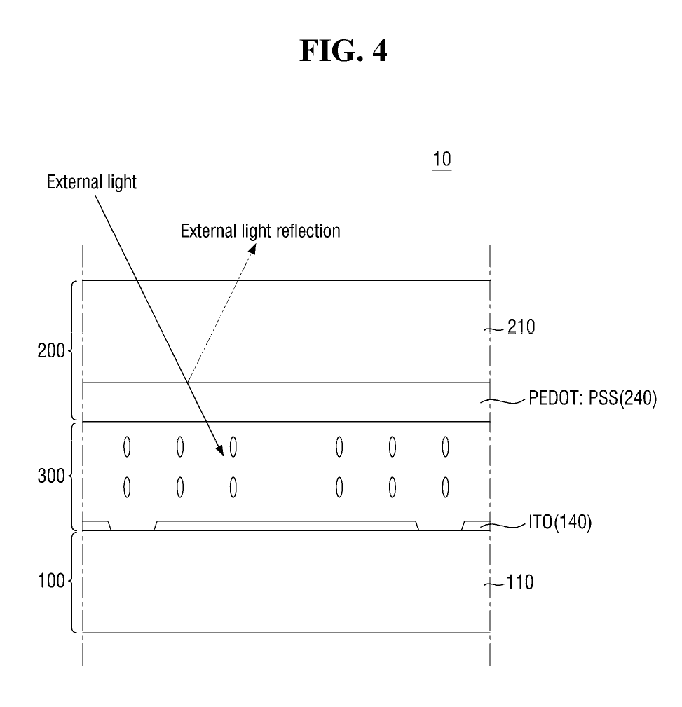

The common electrode 240 may be made of a transparent conductive material. The common electrode 240 may include a conductive polymer material in the transparent conductive material. Examples of the conductive polymer material may include, but are not limited to, polyethylene dioxythiophene (PEDOT), polyethylene dioxythiophene polystyrene sulfonate (PEDOT/PSS), poly(3-alkyl)thiophene (P3AT), poly(3-hexyl)thiophene (P3HT), polyaniline, polyacetylene, polyazulene, polyisothianapthalene, polyisothianaphthene, polythienylenevinylene, polythiophene, polyphenylene, polyphenylene sulfide, polyparaphenylene, polyparaphenylene vinylene, polyfuran, polypyrrole, and polyheptadiene. In an exemplary embodiment, the common electrode 240 may include PEDOT/PSS. The PEDOT/PSS, which is one of the conductive polymer materials, satisfies the transmittance and conductivity required for the common electrode 240, and has a low refractive index, thereby reducing the reflection of external light. Details thereof will be described with reference to FIG. 4.

FIG. 4 is a schematic sectional view illustrating a pixel electrode and a common electrode of a display device according to an exemplary embodiment of the inventive concepts.

FIG. 4 illustrates a case where ITO is used as the material of the pixel electrode 140 and PEDOT/PSS is used as the material of the common electrode 240. As shown in FIG. 4, the common electrode 240 including PEDOT/PSS may have a greater average thickness and a lower refractive index than the pixel electrode 140 including ITO.

The common electrode 240 is disposed on the upper panel 200. When external light is incident, external light may be reflected at the interface. The reflectance of external light becomes larger as the refractive index of the common electrode 240 becomes higher. For example, when an ITO film having a refractive index n of 1.8 to 1.9 is applied to the common electrode 240 to a thickness of about 50 nm, the reflectance thereof approaches 4.47%. When the thickness of the ITO film is increased to 135 nm, the reflectance thereof can be decreased to 1.7, but, even in this case, there is a limitation in reducing the reflectance thereof. In addition, since the ITO film is generally formed by sputtering deposition, it takes a lot of process time and material consumption to increase the thickness of the ITO layer, thereby increasing a process cost.

In contrast, the PEDOT/PSS film may have a refractive index of about 1.5 or less, which is lower than that of the ITO film. Since the PEDOT/PSS film can be formed by slit coating, the process cost can be reduced even if it is formed to have a greater thickness than the ITO film, for example, to a thickness of about 100 to 2000 nm. Within this thickness range, the PEDOT/PSS film may have a surface resistance of 150Ω/□ or less, a transmittance of 88% or more, and a reflectance of less than 1.7%. The reflectance of the PEDOT/PSS film may be 1.5% or less.

In order to determine the reflectance of the PEDOT/PSS film, a glass substrate having a size of 18.2 inch was slit-coated with a PEDOT/PSS material. Then, baking was carried out at 230° C. for 20 minutes to form a PEDOT/PSS film having a thickness of 680 nm. As the results of measuring the physical properties of the formed PEDOT/PSS film, it was found that the PEDOT/PSS film has a surface resistance of 116Ω/□, a transmittance of 89%, and a reflectance of less than 1.4%, and thus, it was ascertained that the PEDOT/PSS film exhibits transparent conductive properties equivalent to those of the ITO film and has a reflectance lower than that of the ITO film.

In the exemplary embodiment of FIG. 4, ITO is applied to the pixel electrode 140, but the pixel electrode 140 may also be made of a conductive polymer material, such as PEDOT/PSS.

FIG. 5 is a sectional view of an upper panel of a display device according to an exemplary embodiment. For convenience of explanation, FIG. 5 is opposite to FIG. 2 in a vertical direction.

Referring to FIGS. 2 and 5, the thickness of the common electrode 240 may vary depending on the location on the common electrode 240. The common electrode 240 may have a thickness d1 in a portion opposed to the pixel electrode 140, that is, in a pixel region, which is greater than the thickness of a portion where the column spacer 230 is disposed. The thickness d4 of the common electrode 240 disposed on the end of the main column spacer 231 may be less than the thickness d3 of the common electrode 240 disposed on the end of the sub-column spacer 232. The common electrode 240 is disposed on the black matrix 220 in a region where the column spacer 230 is not disposed at the boundary of pixels. The thickness d2 of the common electrode 240 disposed on the black matrix 220 may be less than the thickness d1 in the pixel region and greater than the thicknesses d3 or d4 of the common electrode 240 disposed on the end of the column spacer 230.

The difference in the thickness of the common electrode 240 depending on the location on the common electrode is related to the height of the structure based on the second insulation substrate 210. As the height of the underlying structure in which the common electrode 240 is formed increases, the thickness of the common electrode 240 decreases. That is, the common electrode 240 has a first thickness d1, which is greatest, in the pixel region closest to the surface of the second insulation substrate 210, has a second thickness d2 on the black matrix 220, has a third thickness d3 on the end of the sub-column spacer 232 having a height larger than that of the black matrix 220, and has a fourth thickness d4 on the end of the main column spacer 231 having a height larger than that of the sub-column spacer 232. Here, the thickness of the common electrode 240 decreases in order of the first thickness d1, the second thickness d2, the third thickness d3, and the fourth thickness d4.

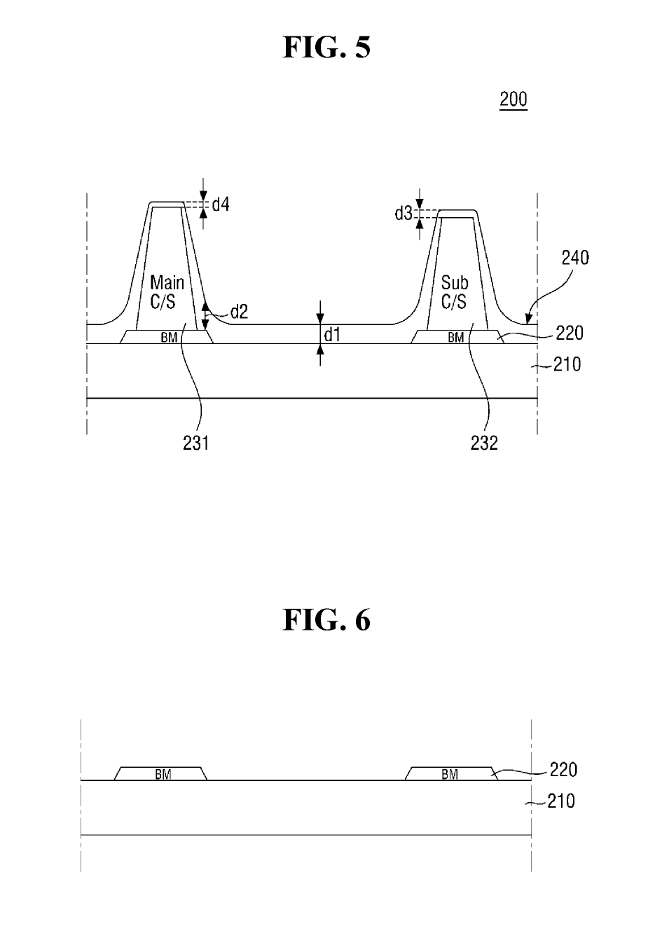

A method of forming the above-described common electrode 240 having a different thickness for each location on the common electrode 240 will be described with reference to FIGS. 6 to 8. FIGS. 6 to 8 are sectional views illustrating a method of manufacturing the upper panel 200 of FIG. 5 according to process step.

Referring to FIG. 6, a black matrix 220 is formed on a second insulation substrate 210. For example, the black matrix 220 may be formed by applying an organic material including a photosensitive material onto the second insulation substrate 210, performing exposure using a mask and then performing development.

Referring to FIG. 7, subsequently, a column spacer 230 is formed. For example, an organic material including a photosensitive material is applied onto the second insulation substrate 210 on which the black matrix 220 is formed. Then, exposure is performed using a mask. A slit mask or a halftone mask may be used as a mask in order to simultaneously form column spacers 230 having different heights through a single process. Then, a developing process is performed to form a main column spacer 231 and a sub-column spacer 232 having different heights from each other.

The above-described step of forming the column spacer 230 is performed before the step of forming the common electrode 240. Generally, a conductive polymer is vulnerable to the developer of the column spacer 230. Accordingly, when the common electrode 240 is first formed and then the column spacer 230 is formed, there is a problem that the common electrode 240 including the conductive polymer is exposed to the developer of the column spacer 230 to be damaged, thereby increasing a surface resistance value. In contrast, when the column spacer 230 is formed first and then the common electrode 240 is formed as in this exemplary embodiment, it is possible to prevent the conductive polymer from being exposed to the developer of the column spacer 230 in advance.

Referring to FIG. 8, a composition including a conductive polymer is applied onto the second insulation substrate 210 on which the column spacer 230 is formed, so as to form a composition layer 240p. The composition further includes a solvent as well as a conductive polymer which is a solid component. Since the solvent is removed in the subsequent process and only the solid components remain, the composition has a much greater thickness than the target common electrode 240. In an exemplary embodiment, the composition may be applied to such a thickness that the entire column spacer 230 is embedded.

Since the composition is in a liquid state, the surface of the composition layer 240p may be flat without reflecting the surface shape of the underlying structure. Thus, the coating thickness (thickness in the vertical direction) of the composition may vary for each region. The composition layer 240p has a fifth thickness d5 in the pixel region, has a sixth thickness d6 on the black matrix 220, has a seventh thickness d7 on the sub-column spacer 232, and has a eighth thickness d8 on the main column spacer 231. Here, the thickness of the composition layer 240p decreases in order of the fifth thickness d5, the sixth thickness d6, the seventh thickness d7, and the eighth thickness d8.

Thereafter, through drying and baking processes, the solvent of the composition is removed, and the conductive polymer, which is a solid component, remains on the second insulation substrate 210, so as to form the common electrode 240 shown in FIG. 5. The greater the thickness of the composition layer 240p, the larger the amount of solid components, so that a thicker layer can be formed. Therefore, as described above, the thickness of the common electrode 240 in the pixel region in which the thickness of the composition layer 240p is greatest is greatest, and the thickness of the common electrode 240 decreases in order of thickness on the black matrix 220, thickness on the end of the sub-column spacer 232, and thickness on the end of the main column spacer 231.

The difference in the thickness of the common electrode 240 for each location increases as the step of the underlying structure increases. The position where the step of the underlying structure is largest may be between the column spacer 230 and the black matrix 220. In this case, the difference between the third thickness d3 and the second thickness d2 and the difference between the fourth thickness d4 and the second thickness d2 may be greater than the difference between the first thickness d1 and the second thickness d2.

The thickness d1 of the common electrode 240 on the pixel area is greater than the thickness of the pixel electrode 140, but each of the thicknesses d2, d3, and d4 of the common electrode 240 at other locations may be greater than, equal to, or less than the thickness of the pixel electrode 140. For example, the fourth thickness d4 of the common electrode 240 on the main column spacer 231, which is the smallest thickness of the common electrode 240, may be greater than the thickness of the pixel electrode 140. In this case, each of the thicknesses of the common electrode 240 at all locations may be greater than the thickness of the pixel electrode 140. As another example, the fourth thickness d4 of the common electrode 240 on the main column spacer 231 may be less than or equal to the thickness of the pixel electrode 140. Moreover, the third thickness d3 of the common electrode 240 on the sub-column spacer 232 may also be less than or equal to the thickness of the pixel electrode 140.

Hereinafter, other exemplary embodiments will be described. In the following exemplary embodiments, the same components as those described in the previous exemplary embodiments will be referred to by the same reference numerals, and redundant descriptions will be omitted or simplified.

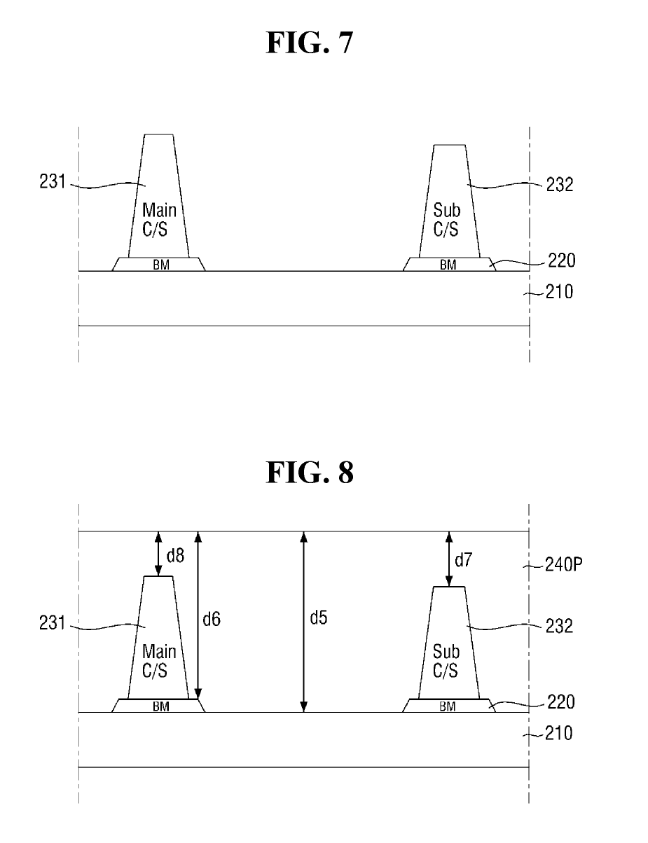

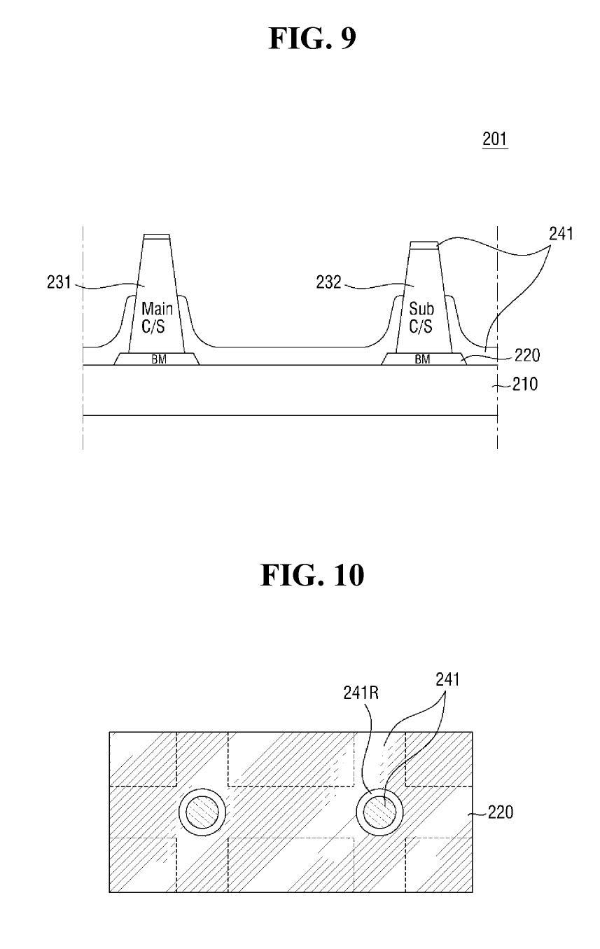

FIG. 9 is a sectional view of an upper panel of a display device according to another exemplary embodiment of the inventive concepts. FIG. 10 is a layout view of the common electrode of FIG. 9.

Referring to FIGS. 9 and 10, an upper panel 201 according to this exemplary embodiment is different from the upper panel 200 according to the exemplary embodiment of FIG. 5 in that a common electrode 241 exposes a part of the side wall of the column spacer 230 without completely covering the column spacer 230.

Specifically, the common electrode 241 is disposed on the end of the column spacer 230, but the upper side wall of the column spacer 230 is exposed without being covered by the common electrode 241. In other words, the thickness of the common electrode 241 on the upper side wall of the column spacer 230 is zero. The lower side wall of the column spacer 230 is covered by the common electrode 241. The height of the common electrode 241 from the surface of the second insulation substrate 210 to the upper end of the lower side wall of the main column spacer 231 is substantially equal to the height of the common electrode 241 from the surface of the second insulation substrate 210 to the upper end of the lower side wall of the sub-column spacer 232.

The common electrode 241 on the lower sidewall of the column spacer 230, which appears to be separated in the sectional view of FIG. 9, is actually integrated while surrounding the end of the column spacer 230, as shown in the plan view of FIG. 10.

The common electrode 241 on the end of the column spacer 230 may be separated from the common electrode 241 on the pixel region. As a result, the common electrode 241 on the end of the column spacer 230 may be a floating electrode. The common electrode 241 may include a ring-shaped open portion 241R around the end of the column spacer 230.

The thickness of the common electrode 241 on the end of the main column spacer 231 may be less than the thickness of the common electrode 241 on the end of the sub-column spacer 232, but the inventive concepts are not limited thereto.

The shape of the common electrode 241 according to this exemplary embodiment is due to the fact that when the composition layer is coated, dried, and baked in the step of manufacturing the upper panel 201 of the display device, solid components flow down near the relatively inclined upper end of the column spacer 230 to be non-remained.

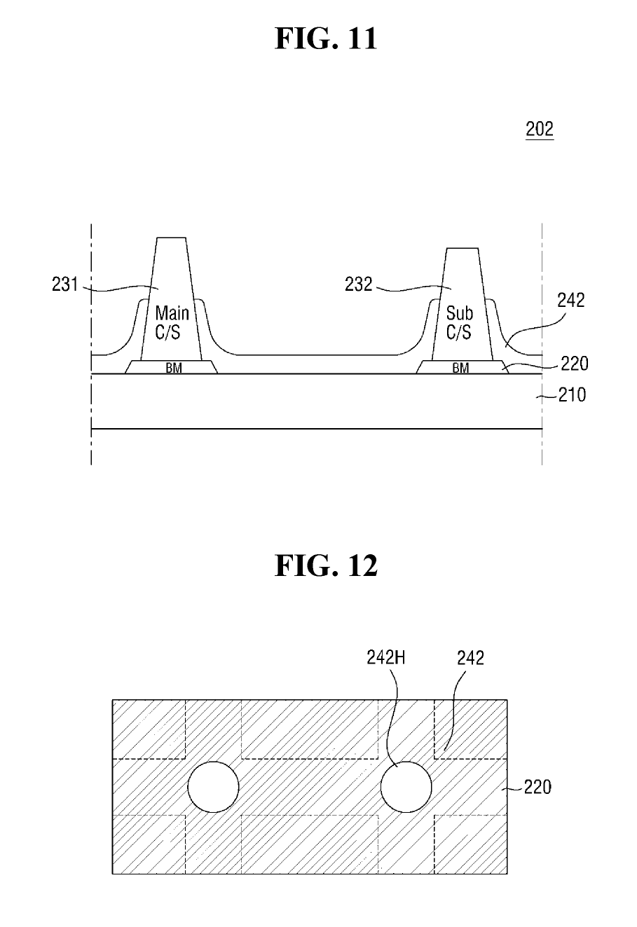

FIG. 11 is a sectional view of an upper panel of a display device according to still another exemplary embodiment. FIG. 12 is a layout view of the common electrode of FIG. 11.

Referring to FIGS. 11 and 12, an upper panel 202 according to this embodiment is different from the upper panel 201 according to the exemplary embodiment of FIGS. 9 and 10 in that a common electrode 242 is not formed on the end of the column spacer 230 as well as on the upper side wall of the column spacer 230, and thus the corresponding portions of the column spacer 230 are exposed. Since the common electrode 242 is not formed even on the end of the column spacer 230, a common electrode hole 242H may be formed at each end of the column spacer as shown in FIG. 12.

The shape of the common electrode 242 according to this exemplary embodiment may be formed when the coating height of the composition layer is less than the height of the column spacer 230 in the step of manufacturing the upper panel 202 of the display device. That is, when the composition layer is applied to such a degree that the end and upper side wall of the column spacer 230 are not embedded in the composition layer, the common electrode 242 formed by drying and baking may not be formed on the end and upper side wall of the column spacer 230.

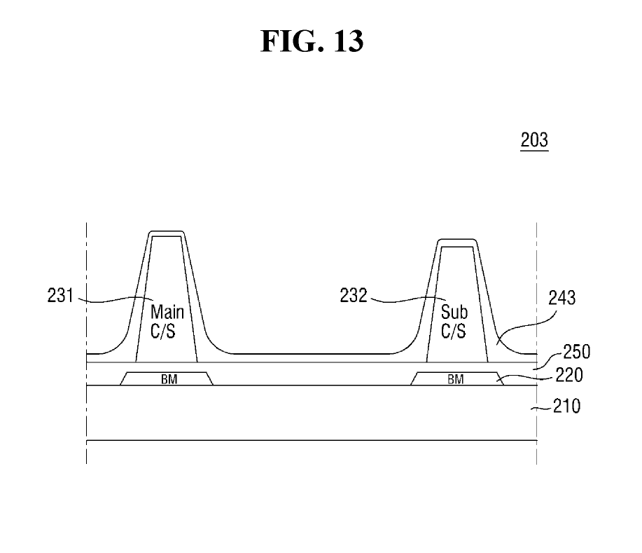

FIG. 13 is a sectional view of an upper panel of a display device according to still another exemplary embodiment.

Referring to FIG. 13, an upper panel 203 according to this exemplary embodiment is different from the upper panel 200 according to the exemplary embodiment of FIG. 5 in that the upper panel 203 further includes an overcoat layer 250 between the black matrix 220 and the column spacer 230. The overcoat layer 250 covers the black matrix 220, and the column spacer 230 is disposed on the overcoat layer 250. Further, a common electrode 243 is disposed on the overcoat layer 250 and covers the column spacer 230.

The overcoat layer 250 is made of an organic insulating material such as polyimide, photoacrylic, or the like, and can function as a planarization layer. The step caused by the black matrix 220 can be eliminated by the overcoat layer 250. Therefore, in the case of this embodiment, the difference in thickness of the common electrode 243 due to the step caused by the black matrix 220, having been described in the embodiment of FIG. 5, may not occur.

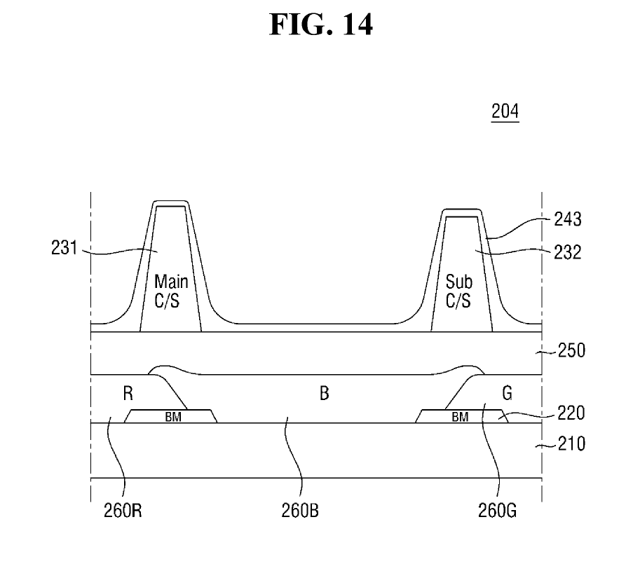

FIG. 14 is a sectional view of an upper panel of a display device according to still another exemplary embodiment.

Referring to FIG. 14, an upper panel 204 according to this exemplary embodiment is different from the upper panel 203 according to the exemplary embodiment of FIG. 13 in that the upper panel 204 includes color filters.

Specifically, the black matrix 220 may be disposed on the second insulation substrate 210, and color filters 260R, 260B, and 260G may be disposed on the black matrix 220. The overcoat layer 250 is disposed on the color filters 260R, 260B, and 260G, and the column spacer 230 is disposed on the overcoat layer 250. The common electrode 243 is disposed on the overcoat layer 250, and is disposed to cover the column spacer 230.

FIG. 14 illustrates that the color filters 260R, 260B, and 260G may be formed in the upper panel 200 rather than the lower panel 100. When the color filters 260R, 260B and 260G are disposed in the upper panel 200, the color filter 120 of the lower panel 100 shown in FIG. 2 may be omitted.

As described above, according to the display device of an exemplary embodiment of the inventive concepts, since a conductive polymer material having a relatively low refractive index is used as the common electrode, the reflection of external light can be reduced. Further, since the common electrode is formed by slit coating or the like, a process cost can be reduced.

According to the method of manufacturing a display device according to an exemplary embodiment of the inventive concepts, since the step of forming the column spacer is completed before the step of forming the common electrode, it is possible to prevent a conductive polymer from being exposed to the developer of the column spacer in advance.

The effects of the present invention are not limited by the foregoing, and other various effects are anticipated herein.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device, comprising:
a first insulation substrate and a second insulation substrate facing each other, the first and second insulation substrates each including a pixel region and a pixel boundary;
a column spacer disposed on the second insulation substrate; and
a common electrode disposed on the second insulation substrate, the common electrode covering at least a part of the column spacer and comprising a conductive polymer.

2. The display device of claim 1, wherein the column spacer is located on the pixel boundary of the second insulation substrate.

3. The display device of claim 2, further comprising a black matrix disposed on the pixel boundary of the second insulation substrate,
wherein the column spacer is disposed on the black matrix.

4. The display device of claim 2, wherein:
the common electrode is disposed on the pixel region of the second insulation substrate and an end of the column spacer; and
a thickness of the common electrode on the pixel region is greater than a thickness of the common electrode on the end of the column spacer.

5. The display device of claim 4, wherein:
the column spacer comprises a main column spacer and a sub-column spacer having a height less than that of the main column spacer; and
a thickness of the common electrode on an end of the main column spacer is less than that of the common electrode on an end of the sub-column spacer.

6. The display device of claim 4, wherein:
the common electrode exposes an upper side wall of the column spacer; and
the common electrode disposed on the end of the column spacer is a floating electrode separated from the common electrode disposed on the pixel region.

7. The display device of claim 2, wherein the common electrode covers a lower side wall of the column spacer and exposes an end and upper side wall of the column spacer.

8. The display device of claim 7, further comprising a pixel electrode disposed on the pixel region of the first insulation substrate, the pixel electrode comprising a transparent conductive oxide material.

9. The display device of claim 8, wherein a reflectance of the common electrode is lower than that of the pixel electrode.

10. The display device of claim 8, wherein:
the common electrode is disposed on the pixel region of the second insulation substrate; and
a thickness of the common electrode disposed on the pixel region is greater than that of the pixel electrode.

11. The display device of claim 1, wherein the common electrode has a refractive index of 1.5 or less.

12. The display device of claim 11, wherein the common electrode has a reflectance of 1.7% or less, a surface resistance of 150Ω/□ or less, and a transmittance of 88%.

13. The display device of claim 1, wherein the common electrode has a thickness of 100 nm to 2000 nm.

14. The display device of claim 1, wherein the common electrode comprises a polyethylene dioxythiophene polystyrene sulfonate (PEDOT/PSS) film.

15. A method of manufacturing a display device, comprising:
forming a column spacer on an insulation substrate;
forming a composition layer comprising a conductive polymer and a solvent on the insulation substrate on which the column spacer is formed; and
forming a common electrode comprising a conductive polymer by removing the solvent.

16. The method of claim 15, wherein the removing of the solvent comprises drying and baking.

17. The method of claim 16, wherein the forming of the column spacer comprises:
applying an organic material; and
performing exposure and development using a mask.

18. The method of claim 17, wherein:
the column spacer comprises a main column spacer and a sub-column spacer having a height less than that of the main column spacer; and
the mask comprises a slit mask or a halftone mask.

19. The method of claim 15, wherein the conductive polymer comprises polyethylene dioxythiophene polystyrene sulfonate (PEDOT/PSS).

20. The method of claim 15, wherein the composition layer is applied to such a thickness that the column spacer is entirely embedded.
